(19) United States
(12) Patent Application Publication
(10) Pub. No.: US 2010/0332539 A1
(43) Pub. Date: Dec. 30, 2010

(54) PRESENTING A RELATED ITEM USING A CLUSTER

(76) Inventors: Sunil Mohan, Los Gatos, CA (US); Roopnath Grandhi, Sunnyvale, CA (US); Stephen Chang, San Francisco, CA (US); Shalini Vikas Agarwal, San Jose, CA (US); Manish K. Kalbande, Sunnyvale, CA (US); Randall Scott Shoup, San Francisco, CA (US)

Correspondence Address: SCHWEGMAN, LUNDBERG & WOESSNER/EBAY, P.O. BOX 2938, MINNEAPOLIS, MN, 55402, US

(21) Appl. No.: 12/495,617

(22) Filed: Jun. 30, 2009

(51) Int. Cl. G06F 17/30

(52) U.S. Cl. 707/776; 707/759; 707/769; 707/802; 707/803; 707/812

(57) ABSTRACT

An initial item is grouped into a cluster defined by a query expression applied to a description of the item. Given the initial item, its associated cluster is accessed, and another item is identified based on the initial item's cluster or from a cluster designated as similar to the initial item's cluster. Once identified, the other item is presented as related to the initial item.

### TECHNICAL FIELD

The subject matter disclosed herein generally relates to information retrieval. Specifically, the present disclosure addresses such methods and apparatus involving presenting a related item using a cluster.

### BACKGROUND

General merchandising of items for sale via a network-based merchandising system is well-known. Many websites accessible via the Internet are operated as online stores or auctions. These websites enable users to purchase items that may be physical items (e.g., an article of clothing), electronic data items (e.g., a downloadable digital media product), or services to be rendered by an affiliated service provider.

To facilitate potential transactions and thereby improve user experiences, some websites provide recommendations of items to users. A recommendation of an item may be provided by sending an e-mail message to a user to notify the user that a popular product is available for sale. Providing a recommendation may also be performed by displaying an advertisement for a best-selling product directly to the user.

Greater sophistication in providing a recommendation to a user may be achieved by selecting an item to be recommended based on user preferences stored in a user profile or based on a history of previous purchases by the user. Additionally, aggregated opinions or ratings of items provided by other users may be used to enhance identification of an item to be recommended.

### BRIEF DESCRIPTION OF THE DRAWINGS

Some embodiments are illustrated by way of example and not limitation in the figures of the accompanying drawings in which:

FIG. 1 is a block diagram illustrating relationships among items and clusters, according to some example embodiments;

FIG. 2 is a block diagram illustrating a cluster dictionary, according to some example embodiments;

FIG. 3 is a block diagram illustrating an item-cluster database, according to some example embodiments;

FIG. 4 is a flow chart illustrating operations in a method, according to some example embodiments, to present a related item using a cluster;

FIG. 5 is a flow chart illustrating operations in a method, according to some example embodiments, to present the related item using multiple clusters;

FIG. 6 is a block diagram illustrating a hardware apparatus, according to some example embodiments, to present a related item using a cluster; and

FIG. 7 is a block diagram illustrating components of an example machine able to read instructions from a machine-readable medium.

### DETAILED DESCRIPTION

Example methods and apparatus are directed to presenting a related item using a cluster. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Items are grouped into clusters that are defined by query expressions applied to descriptions of the items. Given an initial item, its associated cluster is accessed, and another item is identified from the initial item's cluster or from a similar cluster. Once identified, the other item is presented as related to the initial item.

Potential advantages include, but are not limited to, improving the quality of recommendations provided to a user of a network-based merchandising system, reducing computational loads on processing hardware involved in providing recommendations, reducing network traffic involved in users searching for items, and efficiently providing recommendations in situations where items are not assigned to predefined categories.

As used herein, the term “item” refers to a physical or non-physical item potentially or actually available for sale, as well as to a representation of such an item within a network-based merchandising system. As examples, a physical item may be a product or a good (e.g., an article of clothing), and a non-physical item may be a data package (e.g., downloadable digital media content). An example of a representation of an item is an item identifier (e.g., a serial number, an item number, or a sales listing number) assigned to an item by a network-based merchandising system. Another example of a representation of an item is an image of the item (e.g., a picture of an article of clothing).

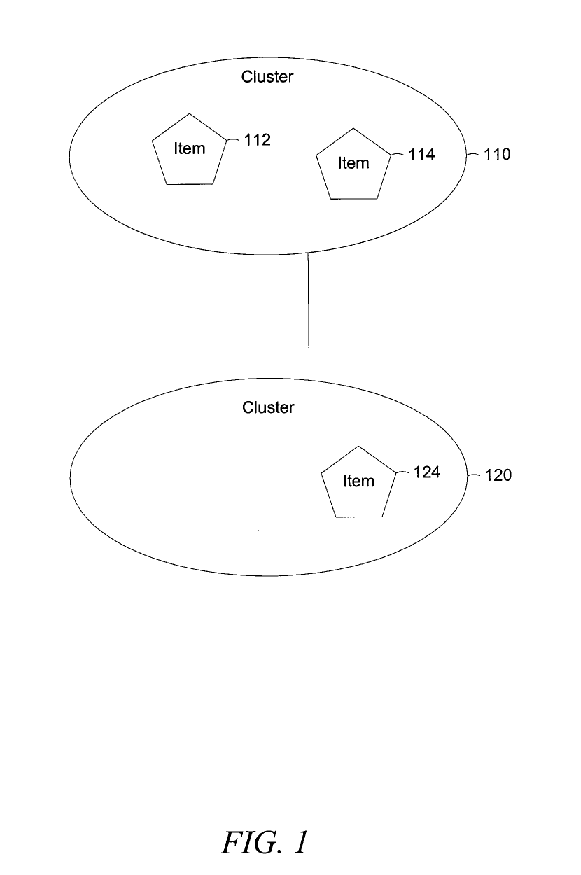

FIG. 1 is a block diagram illustrating relationships among items 112, 114, and 124, and clusters 110 and 120, according to some example embodiments. As used herein, a “cluster” (e.g. cluster 110) is a set of one or more items, each item having been identified by a query expression corresponding to the cluster. A “cluster identifier” (CID), as used herein, is a value (e.g., an alphanumeric value) that uniquely identifies a cluster. A CID is associated with the query expression by a “cluster dictionary” that contains one or more CIDs and their corresponding query expressions.

If an item has been identified by the query expression, the item may be grouped into the corresponding cluster by associating the item with the CID corresponding to the query expression. For example, a cluster dictionary may associate the query expression “men's and red and shirt” with CID “1000.” Within an inventory of items, all items that are men's red shirts satisfy the query expression and may be associated with CID 1000, thus grouping the men's red shirts into that cluster. As used herein, a “query expression” is a set of one or more criteria that defines the membership of items in a cluster. For example, a query expression may be a Boolean expression including one or more keywords functioning as the one or more criteria (e.g., “men's and red and shirt” or “music and player and (digital or analog”).

A cluster may contain any number of items or no items at all. Similarly, an item may be a member of any number of clusters, or no cluster at all. As shown in FIG. 1, a cluster 110 contains two items 112 and 114, while another cluster 120 contains one item 124. The two clusters 110 and 120 are designated as similar to each other, as represented by a line connecting them, as shown in the figure. Using these relationships, if one item 112 is given as an initial item, items 114 and 124 may be identified as related to item 112. Specifically, an item 114 may be identified by selecting from the same cluster 110 as the initial item 112, and another item 124 may be identified by selecting from a cluster 120 designated as similar to the cluster 110 of the initial item 112.

A cluster 110 may be designated as similar to another cluster 120 based on any similarity model or no model at all. In some example embodiments, similarity is based on associative relationship between clusters. For example, an item-cluster database may associate an item with all CIDs of clusters containing the item, as well as with all CIDs of clusters designated within a networked-based merchandising system as sufficiently similar to the clusters containing the item. In various example embodiments, similarity is based on more sophisticated models involving mathematical weighting factors applied to different criteria used in the query expressions defining the clusters. For example, a cluster defined by the query expression “men's and red and shirt” may be designated as more similar to a cluster defined by the query expression “men's and red and hat” than to cluster defined by the query expression “women's and red and shirt” on the basis of giving more weight to clothing type than to the wearer's gender.

Furthermore, an individual item may be designated as similar to another individual item in the same manner as in the designation of similar clusters. All similarity features and operations described herein as applied to clusters may be applied to individual items. For example, descriptions of multiple items may be processed to determine similarity scores relative to a description of a reference item (e.g., FIG. 1, item 112).

As used herein, the term “related” refers to a cluster-based relationship existing between or among items. Two or more items are related to each other if the items are associated together by a direct or indirect cluster relationship. For example, as shown in FIG. 1, items 112, 114, and 124 are all related to each other by the association of clusters 110 and 120. As another example, two clusters may share a common parent cluster encompassing both. This situation arises, for example, where one cluster is defined by the query expression “men's and red and shirt,” another cluster is defined by the expression “men's and blue and shirt,” and the parent cluster is defined by the expression “men's and shirt.” All items in all three clusters are related. As another example, a cluster may have two parent clusters. This situation arises, for example, where the cluster is defined by the query expression “men's and red and shirt,” one parent cluster is defined by the expression “men's and shirt,” and the other parent cluster is defined by the expression “red and shirt.” Again, all items in all three clusters are related.

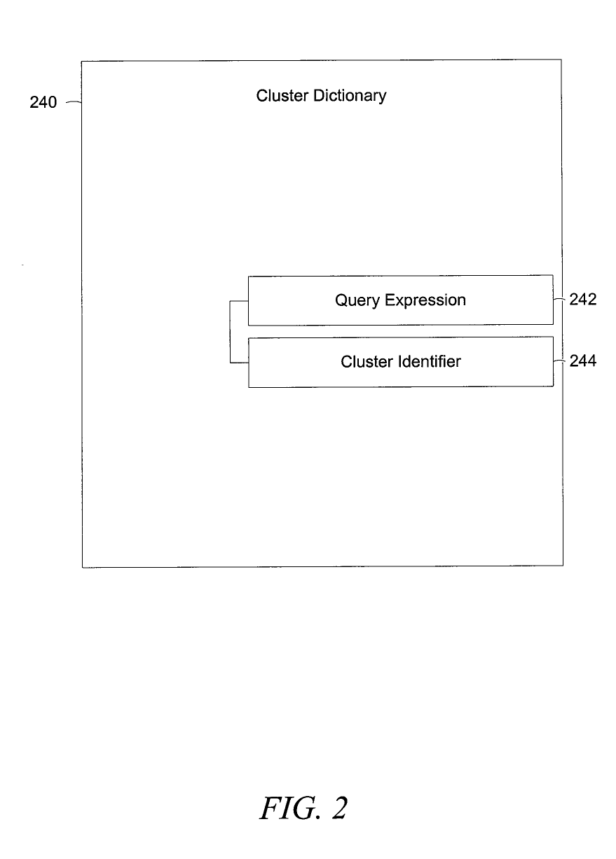

FIG. 2 is a block diagram illustrating a cluster dictionary 240, according to some example embodiments. The cluster dictionary 240 is stored on a machine-readable medium and contains one or more cluster definitions, each cluster definition including a query expression 242 and a CID 244 associated with that query expression 242.

The cluster dictionary 240 is used to assign one or more CIDs to an item, based on one or more query expressions (e.g., query expression 242) contained in the cluster dictionary 240. For example, when receiving an item into an inventory of items, a description of the item may be processed to identify a match between a keyword in the description and a criterion of the query expression 242. If a match is identified, the corresponding CID 244 is assigned to the item, and the item becomes a member of that cluster (e.g., FIG. 1, cluster 110).

Query expressions (e.g., query expression 242) may be of any length, and their criteria may overlap. As a result, clusters may be of any size and may include other clusters (e.g., sub-clusters). Accordingly, the cluster dictionary 240 may define a hierarchy or heterarchy of clusters that includes one or more parent clusters and one or more child clusters. A hierarchy of clusters or a heterarchy of clusters may have any level of sophistication or complexity.

In some example embodiments, the query expression 242 is a predefined query expression received from a server machine or an administrator of a network-based merchandising system. For example, a database of predefined query expressions may be maintained on a server machine within a network-based merchandising system, and periodic updates of this database may be received from the server machine. In certain example embodiments, the query expression 242 is a user-defined query expression received from a user of the network-based merchandising system. For example, the network-based merchandising system may allow users to create their own clusters by submitting their own query expressions.

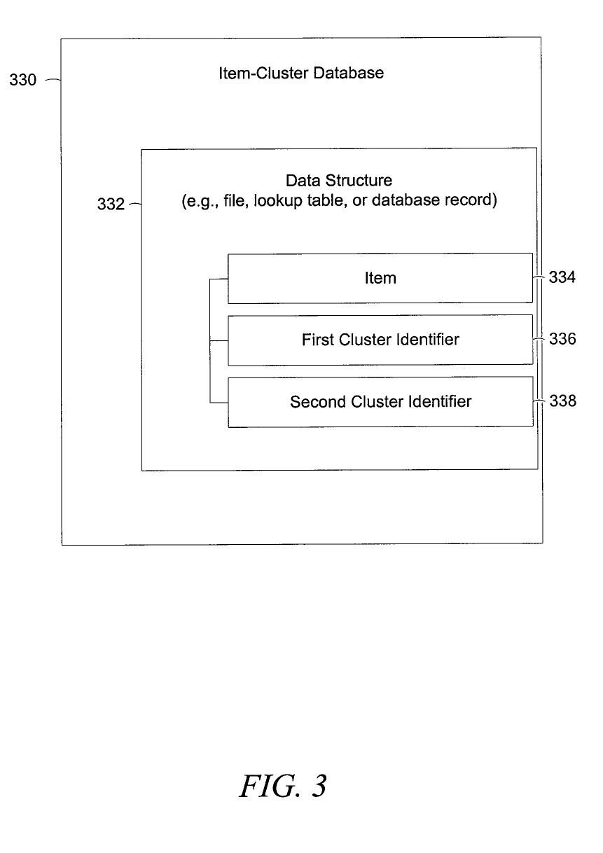

FIG. 3 is a block diagram illustrating an item-cluster database 330, according to some example embodiments. The item-cluster database 330 is stored on a machine-readable medium and contains a data structure 332, which in various example embodiments may be a file, a lookup table, a database record, or any combination thereof.

The data structure 332 contains a set of associated data fields that associate an item 334 (e.g., FIG. 1, item 112) with a first CID 336 (e.g., FIG. 2, CID 224). In some example embodiments, an additional data field in the data structure associates the item 334 with an additional CID 338. In various example embodiments, the additional CID 338 is a second CID designated as similar to the first CID 336. Using the data structure 332, any number of CIDs may be associated with the item 334.

Multiple sets of associated data fields may be contained within the data structure 332. Alternatively, multiple data structures may be contained within the item-cluster database 330. In either case, the item-cluster database 330 allows identification of one or more CDs, given an item. Conversely, the item-cluster database 330 also allows identification of one or more items, given a CID. For example, such identification may be performed via a lookup operation.

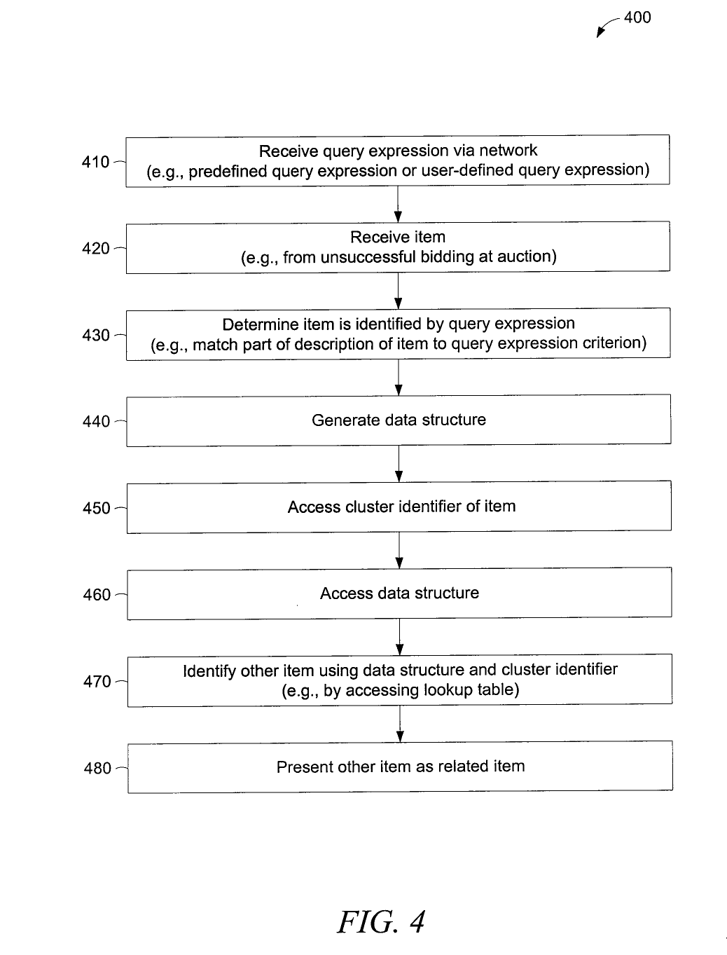

FIG. 4 is a flow chart illustrating operations in a method 400, according to some example embodiments, to present a related item using a cluster (e.g., FIG. 1, cluster 110). In the example embodiment illustrated, operations 410-440 are performed when an item (e.g., FIG. 1, item 112) is received at, listed by, or otherwise made known to a network-based merchandising system, and operations 450-480 are performed when a related item (e.g., FIG. 1, item 114) is to be presented.

Operation 410 involves receiving a query expression (e.g., FIG. 2, query expression 242) via a network (e.g., a local area network, a wide area network, or the Internet). The query expression received may be a predefined query expression or a user-defined query expression, as noted above.

Operation 420 involves receiving an item (e.g., FIG. 1, item 112). For example, where a user of a network-based merchandising system has shown interest in an item, the item may be received from the network-based merchandising system for use in presenting a related item to the user. Interest in an item may be shown, for example, by the user searching for the item, placing the item on a wish list, purchasing the item, or unsuccessfully attempting to purchase the item.

Operation 430 involves determining that the item (e.g., FIG. 1, item 112) is identified by a query expression (e.g., FIG. 2, query expression 242). This has the effect of grouping the item into a cluster (e.g., FIG. 1, cluster 110). For example, the item may have a corresponding description, and operation 430 may include processing the description of the item using the query expression. In some example embodiments, this involves identifying a match between at least a portion of the description and a criterion of the query expression. As an example, an item may have the description “longsleeve men's red shirt,” and a query expression may have the criteria “men's and red and shirt.” In this example, operation 430 identifies the item as having a description that matches the criteria of the query expression and accordingly determines that the item is identified by the query expression. In various example embodiments, operation 430 involves accessing a cluster dictionary (e.g., FIG. 2, cluster dictionary 240) to identify all query expressions satisfied by the description of the item, and thus identify all corresponding CIDs to be associated with the item in operation 440.

Operation 440 involves generating a data structure (e.g., FIG. 3, data structure 332) that associates the identified item (e.g., FIG. 1, item 112) with the CID corresponding to the query expression. The effect of this is to generate or update an item-cluster database (e.g., FIG. 3, item-cluster database 330). For example, a pre-existing item-cluster database may be modified to associate a newly received item (e.g., FIG. 1, item 112) with at least one CID (e.g., FIG. 3, first CID 336).

Operation 450 involves accessing a CID (e.g., FIG. 3, first CID 336) of the item (e.g., FIG. 1, item 112). For example, the CID of the item may be read from an item-cluster database (e.g., FIG. 3, item-cluster database 330). As another example, the CID of the item may be read from metadata associated with a description of the item. As a further example, the CID of the item may be stored in the description itself and read therefrom. For the remainder of this example method 400, this item is referred to as the initial item.

Operation 460 involves accessing a data structure (e.g., FIG. 3, data structure 332) that associates the CID of the initial item from operation 450 with at least one other item (e.g., FIG. 1, item 114). For example, the item-cluster database (e.g., FIG. 3, item-cluster database 330) may be accessed to further access a data structure (e.g., FIG. 3, data structure 332) contained within the item-cluster database.

Operation 470 involves identifying another item (e.g., FIG. 1, item 114) associated with the same CID as the initial item from operation 450. Operation 470 uses the data structure (e.g., FIG. 3, data structure 332) accessed in operation 460 and the CID (e.g., FIG. 3, first CID 336) accessed in operation 450. This has the effect of selecting the other item from the same cluster (e.g., FIG. 1, cluster 110) as the initial item.

Since the initial item (e.g., FIG. 1, item 112) may be associated with multiple CIDs, in some example embodiments, the identifying of the other item (e.g., FIG. 1, item 114) may be based on multiple CDs. In some example embodiments, a subset of these multiple CDs may be used to identify the other item. This feature may be useful where the number of other items identified in operation 470 is very large. Where a subset is used, operation 470 includes determining the subset.

Determination of the subset may be based on a hierarchy or heterarchy of CIDs, one or more lengths of one or more query expressions, one or more numbers of criteria in one or more query expressions, or any combination thereof. For example, using a hierarchy or heterarchy of CIDs may involve limiting the subset to certain children (or grandchildren, great-grandchildren, etc.) CIDs, ignoring one or more parent CIDs, or any combination thereof. As another example, the subset may be limited to CIDs with query expressions above a specified length. As a further example, the subset may be limited to CIDs with query expressions having more than a specified number of criteria.

Operation 480 involves presenting the other item (e.g., FIG. 1, item 114) as the related item. For example, the other item may be displayed to a user of the network-based merchandising system using a user interface of a computer associated with the user.

In some example embodiments, presentation of the other item (e.g., FIG. 1, item 114) is based on a hierarchy or heterarchy of CIDs, one or more lengths of one or more query expressions, one or more numbers of criteria in one or more query expressions, or any combination thereof. For example, where more than one other item is to be presented, a particular other item (e.g., FIG. 1, item 114) may be presented in a distinguished or highlighted manner based on it sharing more clusters in common with the initial item (e.g., FIG. 1, item 112).

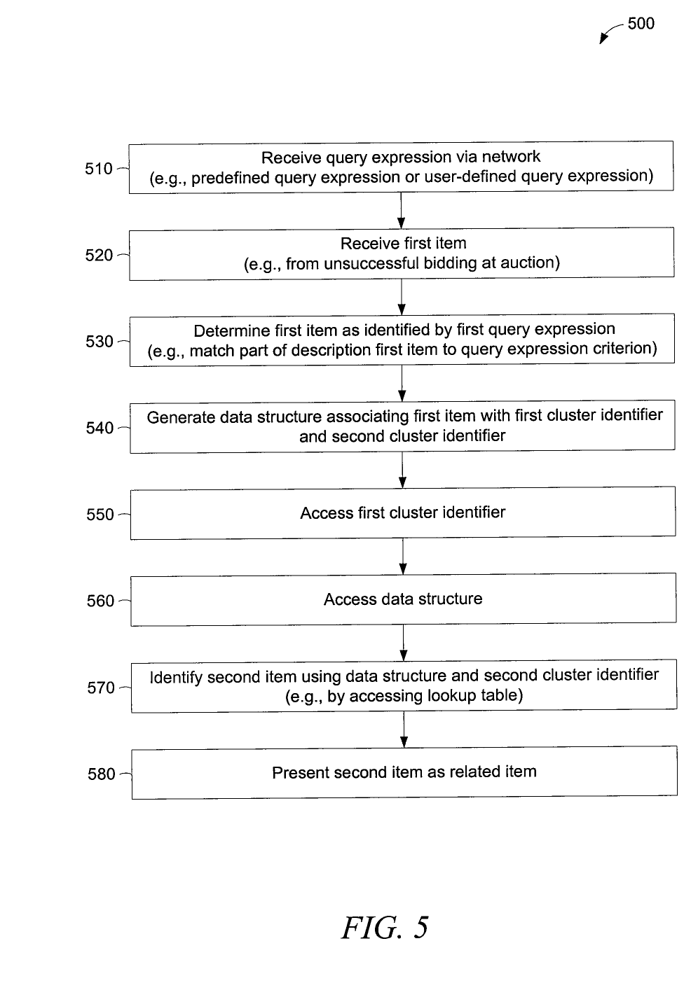

FIG. 5 is a flow chart illustrating operations in a method 500, according to some example embodiments, to present the related item using multiple clusters (e.g., FIG. 1, clusters 110 and 120). In the example embodiment illustrated, operations 510-540 are performed when an item (e.g., FIG. 1, item 112) is received at, listed by, or otherwise made known to a network-based merchandising system, and operations 550-580 are performed when a related item (e.g., FIG. 1, item 114) is to be presented.

Operation 510 involves receiving a query expression (e.g., FIG. 2, query expression 242) via a network (e.g., a local area network, a wide area network, or the Internet). The query expression received may be a predefined query expression or a user-defined query expression, as noted above.

Operation 520 involves receiving a first item (e.g., FIG. 1, item 112). For example, where a user of a network-based merchandising system has shown interest in the first item, the first item may be received from the network-based merchandising system for use in presenting a related item to the user. Interest in the first item may be shown, for example, by the user searching for the first item, placing the first item on a wish list, purchasing the first item, or unsuccessfully attempting to purchase the first item.

Operation 530 involves determining that the first item (e.g., FIG. 1, item 112) is identified by a first query expression (e.g., FIG. 2, query expression 242). This has the effect of grouping the first item into a first cluster (e.g., FIG. 1, cluster 110). For example, the first item may have a corresponding description, and operation 530 may include processing the description of the first item using the first query expression. In some example embodiments, this involves identifying a match between at least a portion of the description and a criterion of the first query expression. As an example, the first item may have the description “longsleeve men's red shirt,” and the first query expression may have the criteria “men's and red and shirt.” In this example, operation 530 identifies the first item as having a description that matches the criteria of the first query expression and accordingly determines that the first item is identified by the first query expression. In various example embodiments, operation 530 involves accessing a cluster dictionary (e.g., FIG. 2, cluster dictionary 240) to identify all query expressions satisfied by the description of the first item, and thus identify all corresponding CIDs to be associated with the first item in operation 540.

Operation 540 involves generating a data structure (e.g., FIG. 3, data structure 332) that associates the identified first item (e.g., FIG. 1, item 112) with a first CD corresponding to the first query expression. The effect of this is to generate or update an item-cluster database (e.g., FIG. 3, item-cluster database 330). For example, a pre-existing item-cluster database may be modified to associate a newly received first item (e.g., FIG. 1, item 112) with the first CD (e.g., FIG. 3, first CID 336).

Operation 550 involves accessing the first CID (e.g., FIG. 3, first CID 336) of the first item (e.g., FIG. 1, item 112). For example, the first CID may be read from an item-cluster database (e.g., FIG. 3, item-cluster database 330). As another example, the first CID may be read from metadata associated with a description of the first item. As a further example, the first CID may be stored in the description itself and read therefrom.

Operation 560 involves accessing a data structure (e.g., FIG. 3, data structure 332) that associates the first CID (e.g., FIG. 3, first CID 336) with a second CID (e.g., FIG. 3, second CID 338) of a cluster (e.g., FIG. 1, cluster 120) corresponding to a second item (e.g., FIG. 1, item 124). For example, the item-cluster database (e.g., FIG. 3, item-cluster database 330) may be accessed to further access a data structure (e.g., FIG. 3, data structure 332) contained within the item-cluster database.

Operation 570 involves identifying the second item (e.g., FIG. 1, item 124). Operation 570 uses the data structure (e.g., FIG. 3, data structure 332) accessed in operation 560 and the second CID (e.g., FIG. 3, second CID 338). This has the effect of selecting the second item from a cluster (e.g., FIG. 1, cluster 120) designated as similar to the first item's cluster (e.g., FIG. 1, cluster 110).

Since the first item (e.g., FIG. 1, item 112) may be associated with multiple CIDs of similar clusters, in some example embodiments, the identifying of the second item (e.g., FIG. 1, item 114) may be based on multiple CDs functioning as second CDs (e.g., FIG. 3, second CID 338). In some example embodiments, a subset of these multiple second CIDs may be used to identify the second item. This feature may be useful where the number of second items identified in operation 570 is very large. Where a subset is used, operation 570 includes determining the subset.

Determination of the subset may be based on a hierarchy or heterarchy of CDs, one or more lengths of one or query expressions, one or more numbers of criteria in one or more query expressions, a similarity score calculated based on a weighting factor corresponding to one or more query expression criteria, or any combination thereof. For example, using a hierarchy or heterarchy of CDs may involve limiting the subset to certain children (or grandchildren, great-grandchildren, etc.) CIDs, ignoring one or more parent CIDs, or any combination thereof. As another example, the subset may be limited to CIDs with query expressions above a specified length. As a further example, the subset may be limited to CIDs with query expressions having more than a specified number of criteria. Additionally, a similarity score may be calculated based on mathematical weighting factors applied to various criteria in the query expressions of the relevant clusters. For example, if the first CID corresponds to a cluster defined by the query expression “men's and red and shirt,” a cluster defined by the query expression “men's and red and hat” may receive a greater similarity score than a cluster defined by the query expression “women's and red and shirt,” on the basis of giving more weight to similarities in clothing type than to similarities in wearer's gender.

Operation 580 involves presenting the second item (e.g., FIG. 1, item 124) as the related item. For example, the second item may be displayed to a user of the network-based merchandising system using a user interface of a computer associated with the user.

In some example embodiments, presentation of the second item (e.g., FIG. 1, item 124) is based on a hierarchy or heterarchy of CIDs, one or more lengths of one or query expressions, one or more numbers of criteria in one or more query expressions, a similarity score calculated based on a weighting factor corresponding to one or more query expression criteria, or any combination thereof. For example, where more than one other item is to be presented, the second item (e.g., FIG. 1, item 114) may be presented in a distinguished or highlighted manner based on it sharing more clusters in common with the first item (e.g., FIG. 1, item 112). As another example, the second item may receive prominent presentation on the basis of membership in a cluster (e.g., FIG. 1, cluster 120) with a high similarity score, calculated with respect to the cluster (e.g., FIG. 1, cluster 110) of the first item (e.g., FIG. 1, item 112).

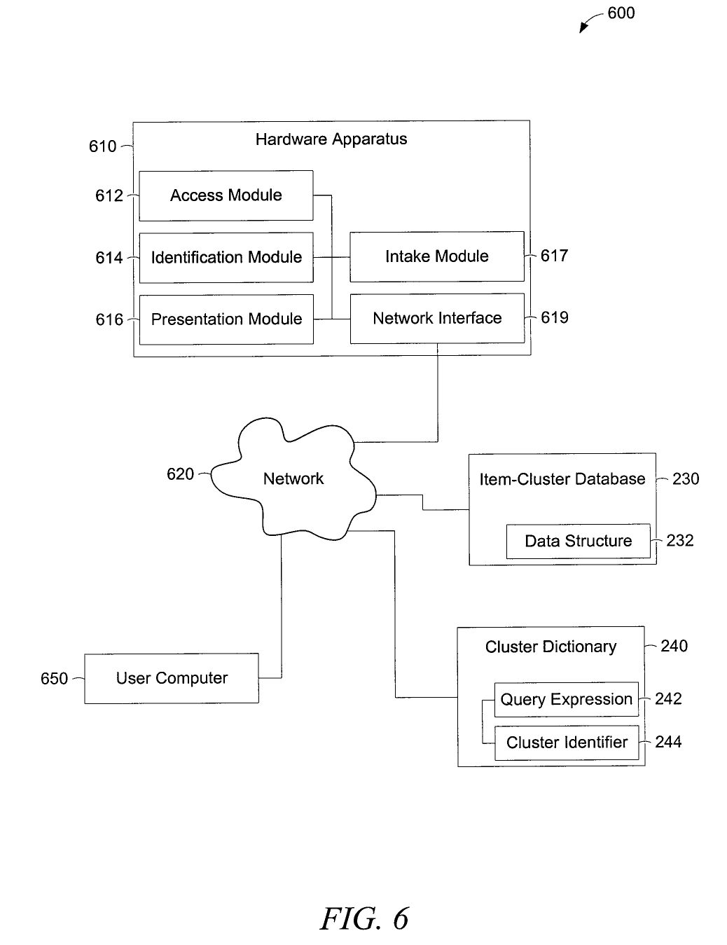

FIG. 6 is a block diagram illustrating a hardware apparatus 610 within a system 600, according to some example embodiments, to present a related item using a cluster. The example system 600 includes the hardware apparatus 610, the item-cluster database 230, the cluster dictionary 240, and a user computer 650, all connected via a network 620.

The hardware apparatus 610 includes an access module 612, an identification module 614, a presentation module 616, an intake module 617, and a network interface 619. The hardware apparatus 610 may be a computer system that implements the access module 612, the identification module 614, the presentation module 616, or any combination thereof, in hardware within the computer system.

The access module 612 is configured to access a CID (e.g., FIG. 3, first CID 336) of a cluster (e.g., FIG. 1, cluster 110) containing a first item (e.g., FIG. 1, item 112) and to access a data structure (e.g., FIG. 3, data structure 332) that associates the CID with a second item (e.g., FIG. 1, item 114) in the same cluster (e.g., FIG. 1, cluster 110), with a different CID (e.g., FIG. 3, second CID 338) of a different cluster (e.g., FIG. 1, cluster 120), or with both. This different cluster contains a third item (e.g., FIG. 1, item 124).

In various example embodiments, the access module 612 is configured to receive one or more query expressions (e.g., FIG. 2, query expression 242) via network 620. As noted above, a query expression received may be a predefined query expression or a user-defined query expression.

The identification module 614 is configured to identify the second item (e.g., FIG. 1, item 114), the third item (e.g., FIG. 1, item 124), or both, by using the data structure (e.g., FIG. 3, data structure 332) and the CID (e.g., FIG. 3, first CID 336) corresponding to the first item (e.g., FIG. 1, item 112). In various example embodiments, the identification module 614 uses the data structure to trace relationships starting from the first item and resulting in identification of the second item, the third item, or any combination thereof.

In some example embodiments, the identification module 614 is further configured to perform the identification of the second item (e.g., FIG. 1, item 114), the third item (e.g., FIG. 1, item 124), or both, based on multiple different CIDs (e.g., FIG. 3, second CID 338). According to certain example embodiments, a subset of these multiple different CIDs may be used to perform this identification. Where a subset is used, the identification module 614 determines the subset. As described above, determination of the subset may be based on a hierarchy or heterarchy of CDs, one or more lengths of one or query expressions, one or more numbers of criteria in one or more query expressions, a similarity score calculated based on a weighting factor corresponding to one or more query expression criteria, or any combination thereof.

In various example embodiments, the identification module 614 is configured to perform the identifying of the second item (e.g., FIG. 1, item 114), the third item (e.g., FIG. 1, item 124), or both, by accessing a lookup table stored on a machine-readable medium.

The presentation module 616 is configured to present the second item (e.g., FIG. 1, item 114), the third item (e.g., FIG. 1, item 124), or both, as one or more items related to the first item (e.g., FIG. 1, item 112). For example, the presentation module 616 may display the second item (e.g., FIG. 1, item 114), the third item (e.g., FIG. 1, item 124), or both, to a user interface of the user computer 650. This has the effect of presenting at least one related item to a user of the user computer 650.

The intake module 617 is configured to receive the first item (e.g., FIG. 1, item 112), to identify the first item by matching at least a portion of a description of the first item with a criterion of the query expression corresponding to the CID (e.g., FIG. 3, first CID 336), and to generate the data structure (e.g., FIG. 3, data structure 332). This has the effect of associating the first item with the CID. According to certain example embodiments, the intake module 617 performs this association prior to the access module 612 accessing the CID.

The network interface 619 may be any network interface able to communicatively couple the hardware apparatus 610 with the network 620. The network 620 may be any wired or wireless network. For example, the network 620 may be a local area network, a wide area network, the Internet, or any combination thereof.

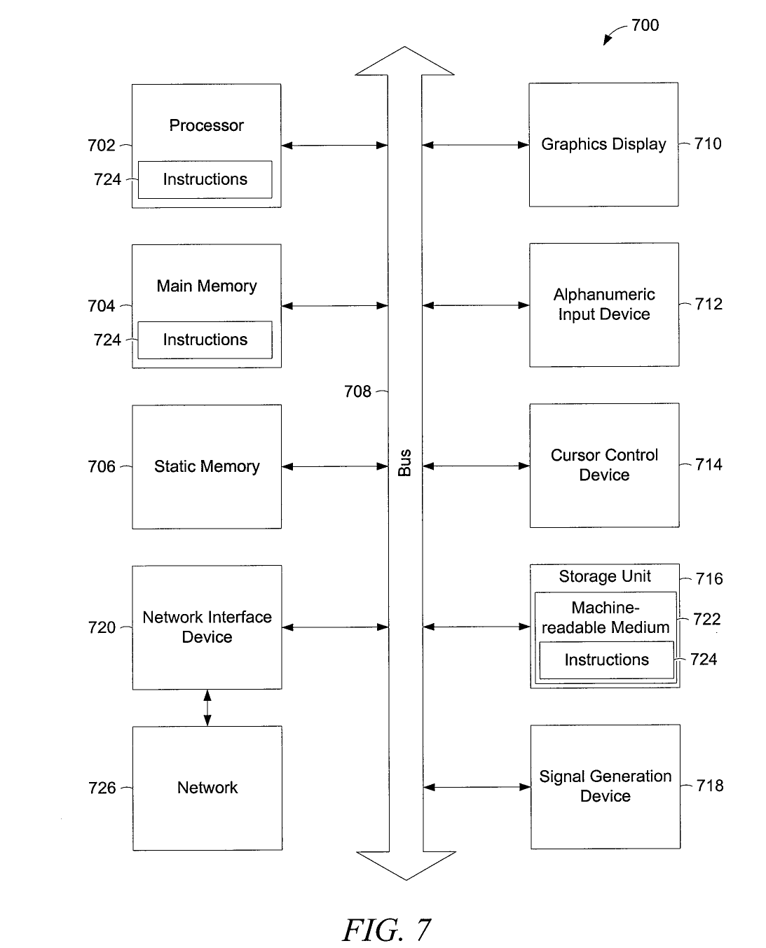

FIG. 7 illustrates components of an example machine able to read instructions from a machine-readable medium. Specifically, FIG. 7 shows a diagrammatic representation of a machine in the example form of a computer system 700 within which instructions 724 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment. The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include a collection of machines that individually or jointly execute instructions 424 to perform any one or more of the methodologies discussed herein.

Computer system 700 includes processor 702 (e.g., a central processing unit (CPU), a graphics processing unit (GPU), a digital signal processor (DSP), application specific integrated circuits (ASICs), radio-frequency integrated circuits (RFICs), or any combination of these), main memory 704, and static memory 706, which communicate with each other via bus 708. Computer system 700 may further include graphics display unit 710 (e.g., a plasma display panel (PDP), a liquid crystal display (LCD), a projector, or a cathode ray tube (CRT)). Computer system 700 may also include alphanumeric input device 712 (e.g., a keyboard), cursor control device 714 (e.g., a mouse, a trackball, a joystick, a motion sensor, or other pointing instrument), storage unit 716, signal generation device 718 (e.g., a speaker), and network interface device 720.

Storage unit 716 includes a machine-readable medium 722 on which is stored instructions 724 (e.g., software) embodying any one or more of the methodologies or functions described herein. Instructions 724 (e.g., software) may also reside, completely or at least partially, within main memory 704 and/or within processor 702 (e.g., within a processor's cache memory) during execution thereof by computer system 700, main memory 704 and processor 702 also constituting machine-readable media. Instructions 724 (e.g., software) may be transmitted or received over network 726 via network interface device 720.

As used herein, the term “memory” refers to a machine-readable medium able to store data temporarily or permanently and may be taken to include, but not be limited to, random-access memory, read-only memory, buffer memory, flash memory, and cache memory. While machine-readable medium 722 is shown in an example embodiment to be a single medium, the term “machine-readable medium” should be taken to include a single medium or multiple media (e.g., a centralized or distributed database, and/or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies described herein. The term “machine-readable medium” shall accordingly be taken to include, but not be limited to, data repositories in the form of solid-state memories, optical media, and magnetic media.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive or, unless specifically stated otherwise.

What is claimed is:

1. A computer-implemented method to present a related item, the method comprising:
accessing via a hardware-implemented module a cluster identifier of an item, the cluster identifier identifying a cluster that represents a plurality of items, each item of the plurality of items identified based on a query expression;
accessing a data structure that associates the cluster identifier with another item in the cluster of items;
identifying the other item using the data structure and based on the cluster identifier; and
presenting the other item as the related item.

2. The computer-implemented method of claim 1 further comprising:
receiving the item;
determining that the item is identified by the query expression; and
generating the data structure to associate the item with the cluster identifier prior to the accessing of the cluster identifier.

3. The computer-implemented method of claim 2, wherein
the determining that the item is identified by the query expression includes processing a description of the item using the query expression to identify a match between at least a portion of the description of the item and a criterion of the query expression.

4. The computer-implemented method of claim 1, wherein
the identifying of the other item is based on a subset of a plurality of cluster identifiers including the cluster identifier.

5. The computer-implemented method of claim 4 further comprising
determining the subset of the plurality of cluster identifiers based on at least one of a hierarchy of cluster identifiers, a heterarchy of cluster identifiers, a length of the query expression, or a number of criteria of the query expression.

6. The computer-implemented method of claim 1 wherein
the presenting of the other item is based on at least one of a hierarchy of cluster identifiers, a heterarchy of cluster identifiers, a length of the query expression, or a number of criteria of the query expression

7. The computer-implemented method of claim 1, wherein
the identifying of the other item includes accessing a lookup table stored on a machine-readable medium.

8. The computer-implemented method of claim 1 further comprising
receiving the query expression via a network, wherein the query expression is at least one of a predefined query expression or a user-defined query expression.

9. A computer-implemented method to present a related item, the method comprising:
accessing via a hardware-implemented module a first cluster identifier of a first item, the first cluster identifier identifying a first cluster of items, each item in the first cluster of items identified based on a first query expression;
accessing a data structure that associates the first cluster identifier with a second cluster identifier of a second item, the second cluster identifier identifying a second cluster of items, each item in the second cluster of items identified based on a second query expression;
identifying the second item using the data structure and based on the second cluster identifier; and
presenting the second item as the related item.

10. The computer-implemented method of claim 9 further comprising:
receiving the first item;
determining that the first item is identified by the first query expression; and
generating the data structure to associate the first item with the first cluster identifier and with the second cluster identifier prior to the accessing of the first cluster identifier.

11. The computer-implemented method of claim 10, wherein
the determining that the first item is identified by the first query expression includes processing a description of the first item using the first query expression to identify a match between at least a portion of the description of the first item and a criterion of the first query expression.

12. The computer-implemented method of claim 9, wherein
the identifying of the second item is based on a subset of a plurality of cluster identifiers including the second cluster identifier.

13. The computer-implemented method of claim 12 further comprising:
determining the subset of the plurality of cluster identifiers based on at least one of a hierarchy of cluster identifiers, a heterarchy of cluster identifiers, a length of the second query expression, a number of criteria of the second query expression, or a similarity score calculated based on a weighting factor corresponding to a criterion of the second query expression.

14. The computer-implemented method of claim 12 wherein
the presenting of the second item is based on at least one of a hierarchy of cluster identifiers, a heterarchy of cluster identifiers, a length of the second query expression, a number of criteria of the second query expression, or a similarity score calculated based on a weighting factor corresponding to a criterion of the second query expression.

15. The computer-implemented method of claim 9, wherein
the identifying of the second item includes accessing a lookup table stored on a machine-readable medium.

16. The computer-implemented method of claim 9 further comprising
receiving the first query expression via a network, wherein the first query expression is at least one of a predefined query expression or a user-defined query expression.

17. An apparatus to present a related item, the apparatus comprising:
a hardware-implemented access module configured to:
access a cluster identifier of a first item, the cluster identifier identifying a cluster of items including the first item, each item in the cluster of items identified based on a query expression corresponding to the cluster; and
access a data structure that associates the cluster identifier with at least one of a second item in the cluster of items or a different cluster corresponding to a different query expression, the different cluster including a third item identified based on the different query expression;
an identification module configured to identify at least one of the second item or the third item using the data structure and based on the cluster identifier; and
a presentation module configured to present at least one of the second item or the third item as the related item.

18. The apparatus of claim 17 further comprising
an intake module configured to
receive the first item;
identify the first item by matching at least a portion of a description of the first item with a criterion of the query expression; and
generate the data structure to associate the first item with the cluster identifier prior to the accessing of the cluster identifier.

19. The apparatus of claim 17, wherein
the identification module is configured to
determine a subset of a plurality of cluster identifiers including the cluster identifier, the determination based on at least one of a hierarchy of cluster identifiers, a heterarchy of cluster identifiers, a length of the query expression, a number of criteria of the query expression, or a similarity score calculated based on a weighting factor corresponding to a criterion of the query expression; and
perform the identifying of at least one of the second item or the third item based on the subset of the plurality of cluster identifiers.

20. The apparatus of claim 17, wherein
the identification module is configured to perform the identifying of at least one of the second item or the third item by accessing a lookup table stored on a machine-readable medium.

21. The apparatus of claim 17, wherein
the access module is configured to receive the query expression via a network, wherein the query expression is at least one of a predefined query expression or a user-defined query expression.

22. A machine-readable storage medium comprising a set of instructions that, when executed by one or more processors of a machine, cause the machine to:
access a cluster identifier of a first item, the cluster identifier identifying a cluster of items including the first item, each item in the cluster of items identified based on a query expression corresponding to the cluster;
access a data structure that associates the cluster identifier with at least one of a second item in the cluster of items or a different cluster corresponding to a different query expression, the different cluster including a third item identified based on the different query expression;
identify at least one of the second item or the third item using the data structure and based on the cluster identifier; and
present at least one of the second item or the third item as related to the first item.

23. A system to present a related item, the system comprising:
means for accessing a cluster identifier of a first item, the cluster identifier identifying a cluster of items including the first item, each item in the cluster of items identified based on a query expression corresponding to the cluster;
means for accessing a data structure that associates the cluster identifier with at least one of a second item in the cluster of items or a different cluster corresponding to a different query expression, the different cluster including a third item identified based on the different query expression;
means for identifying at least one of the second item or the third item using the data structure and based on the cluster identifier; and
means for presenting at least one of the second item or the third item as the related item.
